(19) United States
(12) Patent Application Publication
(10) Pub. No.: US 2026/0269783 A1
(43) Pub. Date: Sep. 10, 2026

(54) SOLAR ENERGY POWER SUPPLY INTEGRATED MODULE UNIT

(71) Applicant: Bin WANG, Shenzhen (CN)

(72) Inventor: Bin WANG, Shenzhen (CN)

(21) Appl. No.: 19/662,572

(22) Filed: Apr. 29, 2026

(51) Int. Cl. H02S 40/38; H02J 7/35; H02J 7/80; H02S 40/36; H02J 101/24

(52) U.S. Cl. CPC H02S 40/38; H02J 7/35; H02J 7/80; H02S 40/36; H02J 2101/25

(57) ABSTRACT

Provided is a solar energy power supply integrated module unit,. The unit mainly includes: a housing component; a solar panel provided on the housing component, and a light facing surface of the solar panel is exposed from the housing component, a main control module provided inside the housing component and electrically connected to the solar panel; an energy storage battery provided inside the housing component and electrically connected to the main control module; an expansion or load interface, electrically connected to the main control module and/or the energy storage battery, and connected to a load or an expansion or load interface of another integrated solar energy supply and storage module unit; and a shell splicing module configured to connect a housing component of another solar energy power supply integrated module unit.

### TECHNICAL FIELD

The present disclosure relates to the field of solar energy technologies, and in particular, to a solar energy power supply integrated module unit.

### BACKGROUND

The existing solar module splicing is only splicing photovoltaic panels, that is, splicing the power generation part, and after splicing, it is connected to a unified independent energy storage unit. It does not equip each fast solar panel with an independent energy storage unit and enable these energy storage units to be spliced together and maintain the same output voltage. So, each solar panel cannot be used as a separate power source, and the entire system cannot be arbitrarily expanded or reduced in capacity due to different power requirements of the load.

Given the above situation, it is necessary to propose a highly flexible solar energy power supply integrated module unit.

In order to solve the above technical problems, the present disclosure adopts a technical solution for a solar energy power supply integrated module unit, including:

a housing component;

a solar panel, which is provided on the housing component, and a light facing surface of the solar panel is exposed from the housing component;

a main control module, which is provided inside the housing component and electrically connected to the solar panel;

an energy storage battery, which is provided inside the housing component and electrically connected to the main control module;

an expansion or load interface, which is electrically connected to the main control module and/or the energy storage battery, and connected to a load or connected to an expansion or load interface of another solar energy power supply integrated module unit; and

a shell splicing module, configured to connect a housing component of another solar energy power supply integrated module unit.

In some embodiments of the present disclosure, the shell splicing module includes one of a magnetic splicing module, a screw/bolt splicing module, a buckle splicing module, and a slider and sliding groove splicing module.

In some embodiments of the present disclosure, the housing component is polygonal.

In some embodiments of the present disclosure, there are one or more expansion or load interfaces.

In some embodiments of the present disclosure, the housing component is provided with an installation frame on a backlight surface of the solar panel, and an installation part is provided inside the installation frame; the main control module and the energy storage battery are configured in the installation part, and the expansion or load interface is provided on the installation part, the installation frame has a wire passing position corresponding to the expansion or load interface.

In some embodiments of the present disclosure, the installation part is shaped adapted to an outer contour of the housing component.

In some embodiments of the present disclosure, the main control module includes an input management, a first transformer module, a voltage stabilization circuit, a voltage and current sampling module, a MCU, an energy storage monitoring, an output management, and an output module, where the solar panel is connected to the input management, and the input management is respectively connected to the first transformer module and the voltage current sampling module; the first transformer module is connected to the MCU through the voltage stabilization circuit, and the voltage current sampling module is connected to the MCU; the MCU is connected to the energy storage battery through the energy storage monitoring, and the MCU and the energy storage battery are connected to the output management; the output management is connected to the output module, and the output module is connected to a plurality of expansion or load interfaces.

In some embodiments of the present disclosure, the output module includes a second transformer module and a series parallel circuit.

In some embodiments of the present disclosure, the main control module further includes a backup circuit, one end of backup circuit is connected to the mains power, and the other end is connected to the input management.

The beneficial effect of the present disclosure is that the solar panel, main control module, and energy storage battery are integrated through the housing component, that is, each photovoltaic panel is provided with an energy storage battery. The splicing of the solar energy power supply integrated module unit is no longer just splicing the solar panel, but splicing the solar panel and the energy storage battery. The area of the solar panel and the capacity of the energy storage battery increase with the number of splices, so that it can freely increase or decrease the area of the solar panel and the capacity of the energy storage battery according to the electricity demand of the load so as to meet various different electricity needs and avoid waste and insufficient capacity problems. The shell splicing module is used for mechanically splicing the housing components of different solar energy power supply integrated module units, and the expansion or load interface is used for electrical connection of different solar energy power supply integrated module units, so as to organically combine different solar energy power supply integrated module units together, thereby changing the solar panel capacity and energy storage battery capacity to meet different loads and scene site requirements.

### BRIEF DESCRIPTION OF DRAWINGS

FIG. 1 is a schematic structural diagram of a solar energy power supply integrated module unit according to an embodiment of the present disclosure.

FIG. 2 is a schematic structural diagram of the solar energy power supply integrated module unit in another direction according to an embodiment of the present disclosure.

FIG. 3 is a schematic diagram of a splicing structure of the solar energy power supply integrated module unit according to an embodiment of the present disclosure.

FIG. 4 is a schematic diagram of a circuit module structure of the solar energy power supply integrated module unit according to an embodiment of the present disclosure.

FIG. 5 is a schematic diagram of a circuit module structure of the solar energy power supply integrated module unit according to another embodiment of the present disclosure.

FIG. 6 is a schematic diagram of a circuit principle of the solar energy power supply integrated module unit according to an embodiment of the present disclosure.

FIG. 7 is a schematic circuit diagram of the solar energy power supply integrated module unit according to another embodiment of the present disclosure.

Numeral reference:100- housing component; 110- installation frame; 111- wiring position; 120- installation part; 200- solar panel; 300- main control module; 310- input management; 320- first transformer module; 330- voltage stabilization circuit; 340- voltage and current sampling module; 350- MCU; 360- energy storage monitoring; 370- output management; 380- output module; 381- second transformer module; 382- series parallel circuit; 400- energy storage battery; 500- expansion or load interface; 600- shell splicing module; 700- backup circuit; 710- sampling and filtering module; 720- control switch; 730- voltage stabilization module.

### DESCRIPTION OF EMBODIMENTS

In order to clarify the purpose, technical solution, and advantages of the present disclosure, a solar energy power supply integrated module unit of the present disclosure will be further described in detail with reference to the accompanying drawings and embodiments. It should be understood that specific embodiments described herein are only for explaining the present disclosure and are not intended to limit the present disclosure.

Please refer to FIGS. 1-7, a solar energy power supply integrated module unit, including:

a housing component 100;

a solar panel 200, which is provided on the housing component 100, and a light facing surface of the solar panel 200 is exposed from the housing component 100;

a main control module 300, which is provided inside the housing component 100 and electrically connected to the solar panel 200;

an energy storage battery 400, which is provided inside the housing component 100 and electrically connected to the main control module 300;

an expansion or load interface 500, which is electrically connected to the main control module 300 and/or energy storage battery 400, and connected to a load or connected to an expansion or load interface 500 of another solar energy power supply integrated module unit; and

a shell splicing module 600, configured to connect a housing component 100 of another solar energy power supply integrated module unit.

The solar panel 200, the main control module 300, and the energy storage battery 400 are integrated into one through the housing component 100, that is, each photovoltaic panel is provided with one energy storage battery 400. The splicing of the solar energy power supply integrated module unit is no longer just splicing the solar panel 200 but splicing the solar panel 200 and the energy storage battery 400 together. An area of the solar panel 200 and a capacity of the energy storage battery 400 increase with the number of splices, so that a user can arbitrarily increase or decrease the area of the solar panel 200 and the capacity of the energy storage battery 400 according to the electricity demand of the load, to freely meet various different electricity needs, avoiding waste and insufficient capacity problems. The shell splicing module 600 is used for mechanically splicing the housing components 100 of different solar energy power supply integrated module units, and the expansion or load interface 500 is used for electrical connection of different solar energy power supply integrated module units, so as to organically combine different solar energy power supply integrated module units together, thereby changing the capacity of the solar panel 200 and the capacity of the energy storage battery 400 to meet different loads and scene site requirements.

In an implementation mode, the shell splicing module 600 includes one of a magnetic splicing module, a screw/bolt splicing module, a buckle splicing module, or a slider and sliding groove splicing module. The magnetic splicing module refers to an installation of magnets at an edge of the housing component 100, which is connected to the magnets of another solar energy power supply integrated module unit. Typically, the magnetic connection is not stable enough and requires auxiliary mechanical limiting structures, such as convex block and recesses (including mortise and tenon connections) for limiting. The screw/bolt splicing module, which provides connection holes on the installation frame 110 and connects them to the connection holes through connection plates and screws/bolts. The buckle splicing module can be provided with a hook on one module unit, a buckle ring on another module unit, or two module units can be provided with buckle rings. Independent connectors can connect the two buckle rings and lock them with their own buckles. The slider and sliding groove splicing module refers to one module unit having a slider and the other module unit having a sliding groove. In an implementation mode, adjacent edges of the same module unit have the slider and the other having the sliding groove. In an implementation mode, the sliding groove opens to one end and has a baffle at the other end.

In an implementation mode, the housing component 100 is polygonal, it is convenient for splicing, and the pattern after splicing is beautiful. In an implementation mode, an outer contour of the housing component 100 is a regular polygon. In an implementation mode, the housing component 100 is square in shape.

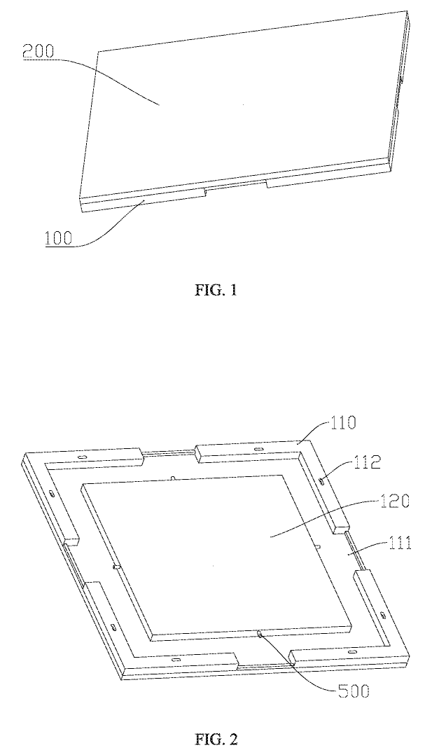

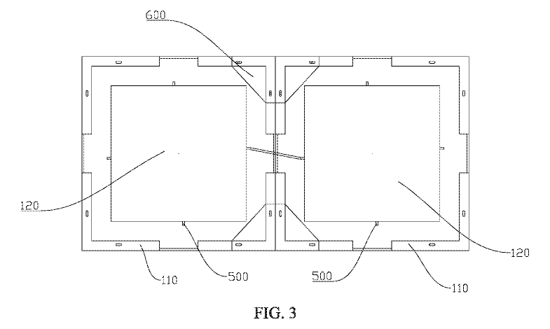

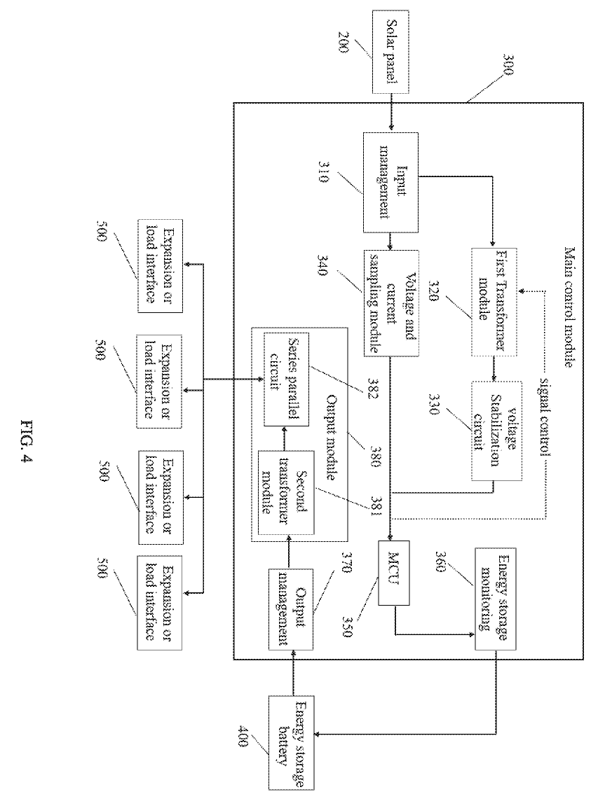

Please refer to FIGS. 2 and 3, there are one or more expansion or load interfaces 500. In an implementation mode, each side of the housing component 100 is provided with the expansion or load interface 500. Generally, each side of the regular polygon can fit with an edge of another module unit, and the expansion or load interface 500 is provided on each side to facilitate an electrical connection with the other module unit.

Please refer to FIGS. 2 and 3. The housing component 100 is provided with an installation frame 110 on a backlight surface of the solar panel 200. The installation frame 110 is provided with an installation part 120, and the main control module 300 and the energy storage battery 400 are provided in the installation part 120. The expansion or load interface 500 is provided on the installation part 120, and the installation frame 110 has a wiring position 111 corresponding to the expansion or load interface 500. Providing the installation frame 110 not only facilitates the splicing of the housing component 100 but also protects the installation part 120. In an implementation mode, the installation frame 110 is slightly higher than the installation part 120.

Please refer to FIGS. 2 and 3, the installation part 120 has a similar shape to the outer contour of the housing component 100, it is convenient to arrange the expansion or load interface 500.

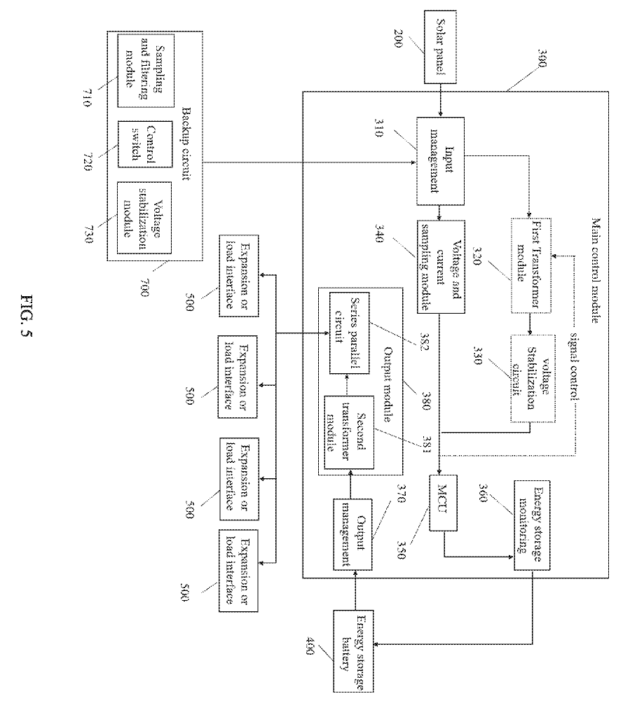

Please refer to FIGS. 4-7, the main control module 300 includes an input management 310, a first transformer module 320, a voltage stabilization circuit 330, a voltage and current sampling module 340, a microcontroller unit, (MCU) 350, an energy storage monitoring 360, an output management 370, and an output module 380. The solar panel 200 is connected to the input management 310, and the input management 310 in turn is connected to the first transformer module 320 and the voltage and current sampling module 340. The first transformer module 320 is connected to the MCU 350 through the voltage stabilization circuit 330, and the voltage and current sampling module 340 is connected to the MCU 350. The MCU350 is connected to the energy storage battery 400 through the energy storage monitoring 360. The MCU350 and the energy storage battery 400 are connected to the output management 370, and the output management 370 is connected to the output module 380. The output module 380 is connected to a plurality of expansion or load interfaces 500.

Please refer to FIGS. 4-7, the output module 380 includes a second transformer module 381 and a series parallel circuit 382. Providing the second transformer module 381 facilitates the control of output voltage to adapt to different loads. Providing the series parallel circuit 382 facilitates electrical connections between different module units. By using the second transformer module 381, the output voltage of any load port of the spliced unit can be kept constant, consistent with the output voltage of a single unit.

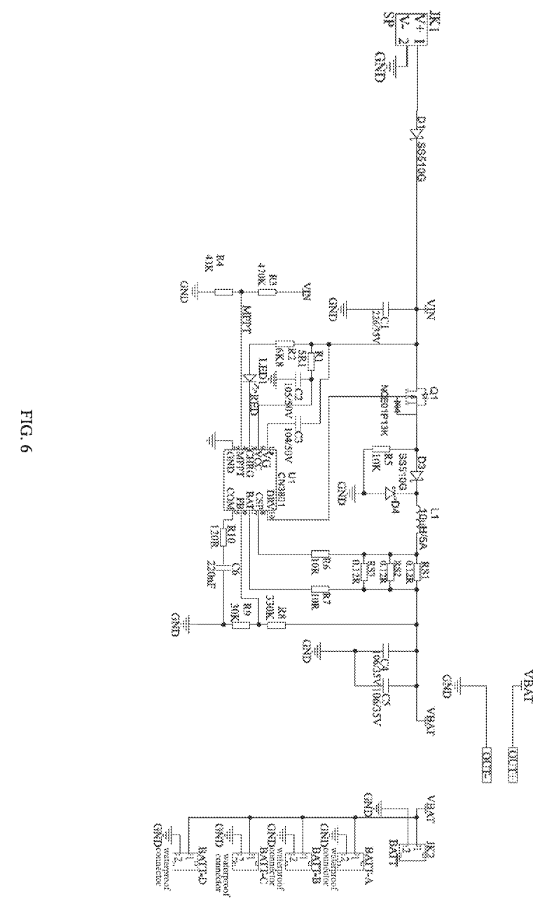

Please refer to FIGS. 5 and 7. The main control module 300 further includes a backup circuit 700, and one end of the backup circuit 700 is connected to the mains power, and the other end thereof is connected to the input management 310. Providing the backup circuit 700, which can serve as an emergency backup for charging the energy storage module in special circumstances. When the weather is bad, it can be recharged from the mains power. In an implementation mode, the backup circuit 700 includes a sampling and filtering module 710, a control switch 720, and a voltage stabilization module 730.

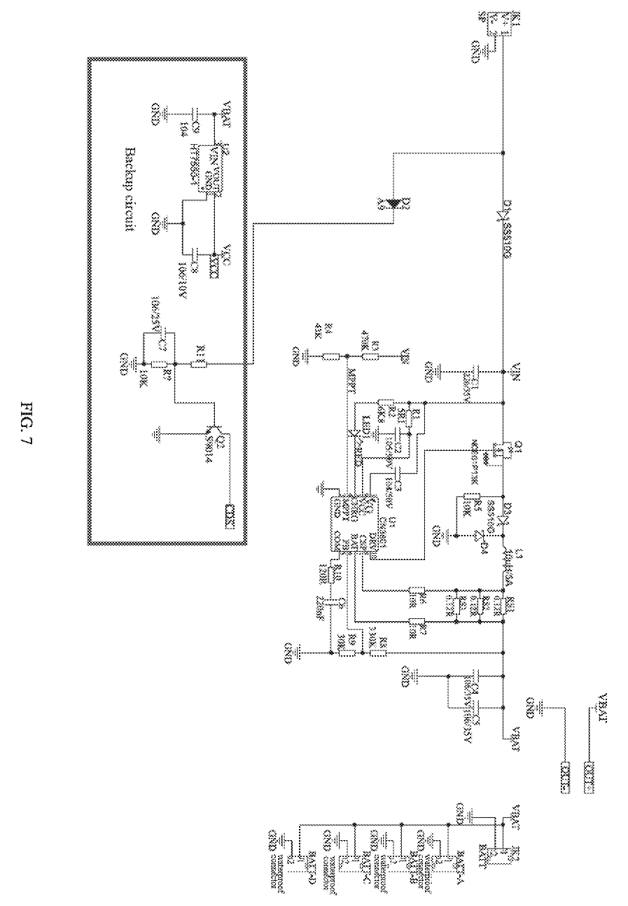

Please refer to FIGS. 6 and 7. U1 is a solar charging management chip, that is MCU 350, which uses CN3805 (Shanghai Ruyun Electronics Co., Ltd.) and integrates Maximum power point tracking, (MPPT) algorithm for constant current/constant voltage charging. Q1 is a P-channel Metal-Oxide-Semiconductor Field-Effect Transistor, (MOSFET), used as an electronic switch, that is the output management 370, to control the discharge circuit of the battery to the load, with low on resistance and efficient voltage reduction. D1 diode is used for anti-reverse connection, i.e. the input management 310. RS1, RS2, and RS3 form a current sampling resistor, and the maximum current of the circuit is increased from 0.83A to 2.5A, which can be adapted to higher power solar panels. At the same time, R6 and R7 serve as matching resistors to balance the sampling signal and eliminate common mode interference. C3 is connected to an MPPT pin, adjusts the response speed of maximum power point tracking, and smoothly tracks the 200-peak power of the solar panel. C4 and C5 are high-capacity electrolytic capacitors used as output terminals to filter out ripples and stabilize the output voltage. L7 inductor, combined with MOSFET and diode, forms a Buck step-down chopper circuit to achieve the conversion of solar voltage to lithium battery voltage.

Please refer to FIG. 7. In the backup circuit 700, U2 uses HT7550-1 and Low Dropout, (LDO) linear regulator from Taiwan Hetai Semiconductor to stabilize the mains voltage and output it to 5V to power the system control circuit. C8 is an output filtering capacitor, C9 is an input filtering capacitor, and C7 is a decoupling filtering capacitor. Q2 is an Negative-Positive-Negative, (NPN) transistor that forms a power failure detection switch.

It should be noted that if directional indications (such as up, down, left, right, front, back, etc.) are involved in the embodiments of the present disclosure, the directional indications are only used to explain the relative position relationship and motion of the components in a specific posture (as shown in the attached figure). If the specific posture changes, the directional indications will also change accordingly.

Besides that, if there are descriptions related to “first”, “second”, etc. in the embodiments of the present disclosure, descriptions of “first”, “second”, etc. are only for descriptive purposes and cannot be understood as indicating or implying their relative importance or implying the number of technical features indicated. Therefore, the features that are limited to “first” and “second” can explicitly or implicitly include at least one of these features.

In summary, the present disclosure provides a solar energy power supply integrated module unit, which integrates solar panels, main control modules, and energy storage batteries through the housing component. Each photovoltaic panel is provided with one energy storage battery, and the splicing of the solar energy power supply integrated module unit is no longer just splicing the solar panels but splicing the solar panels and energy storage batteries. This splicing does not change the output voltage and can be infinitely spliced and maintaining the final output voltage unchanged. The area of the solar panel and the capacity of the energy storage battery increase with the increase of splicing quantity, so that the area of the solar panel and the capacity of the energy storage battery can better adapt to the load demand, avoiding waste or insufficient capacity problems. The shell splicing module is used for mechanically splicing the housing components of multiple solar energy power supply integrated module units, and the expansion or load interface is used for electrical connection and load connection of multiple solar energy power supply integrated module units, to organically combine different solar energy power supply integrated module units together.

The above description is only preferred embodiment of the present disclosure and does not limit the present disclosure in any form. Although the present disclosure has been disclosed in the preferred embodiment, it is not intended to limit the present disclosure. Those skilled in the art can use the disclosed technical content to make slight changes or modifications to equivalent embodiments without departing from the scope of the technical solution of the present disclosure. Any simple modifications, equivalent changes, and modifications made to the above embodiments based on the technical essence of the present disclosure without departing from the technical solution of the present disclosure still belong to the scope of the technical solution of the present disclosure.

What is claimed is:

1. A solar energy power supply integrated module unit, comprising:
a housing component;
a solar panel, which is provided on the housing component, and a light facing surface of the solar panel is exposed from the housing component;
a main control module, which is provided inside the housing component and electrically connected to the solar panel;
an energy storage battery, which is provided inside the housing component and electrically connected to the main control module;
an expansion or load interface, which is electrically connected to the main control module and/or the energy storage battery, and connected to a load or connected to an expansion or load interface of another solar energy power supply integrated module unit; and
a shell splicing module, configured to connect a housing component of another solar energy power supply integrated module unit.

2. The solar energy power supply integrated module unit according to claim 1, wherein the shell splicing module comprises one of a magnetic splicing module, a screw/bolt splicing module, a buckle splicing module, and a slider and sliding groove splicing module.

3. The solar energy power supply integrated module unit according to claim 1, wherein the housing component is polygonal.

4. The solar energy power supply integrated module unit according to claim 1, wherein there are one or more expansion or load interfaces.

5. The solar energy power supply integrated module unit according to claim 4, wherein the housing component is provided with an installation frame on a backlight surface of the solar panel, and an installation part is provided inside the installation frame; the main control module and the energy storage battery are configured in the installation part, and the expansion or load interface is provided on the installation part, the installation frame has a wire passing position corresponding to the expansion or load interface.

6. The solar energy power supply integrated module unit according to claim 5, wherein the installation part is shaped adapted to an outer contour of the housing component.

7. The solar energy power supply integrated module unit according to claim 1, wherein the main control circuit module comprises an input management, a first transformer circuit, a voltage stabilization circuit, a voltage and current sampling circuit, a microcontroller unit, an energy storage monitoring circuit, an output management circuit, and an output circuit module,
wherein the solar panel is connected to the input management, and the input management is respectively connected to the first transformer module and the voltage current sampling module;
the first transformer module is connected to the MCU through the voltage stabilization circuit, and the voltage current sampling module is connected to the MCU;
the MCU is connected to the energy storage battery through the energy storage monitoring, and the MCU and the energy storage battery are connected to the output management;
the output management is connected to the output module, and the output module is connected to a plurality of expansion or load interfaces.

8. The solar energy power supply integrated module unit according to claim 7, wherein the output module comprises a second transformer module and a series parallel circuit.

9. The solar energy power supply integrated module unit according to claim 7, wherein the main control module further comprises a backup circuit, one end of backup circuit is connected to the mains power, and the other end is connected to the input management.
